(19) United States
(12) Patent Application Publication
(10) Pub. No.: US 2017/0050343 A1
(43) Pub. Date: Feb. 23, 2017

(54) SUPERHYDROPHOBIC STRUCTURE AND METHOD OF MAKING THE SAME

(71) Applicant: NATIONAL TSING HUA UNIVERSITY, Hsinchu City (TW)

(72) Inventors: Zung-Hang WEI, Hsinchu City (TW); Chen-Yu HUANG, Hsinchu City (TW)

(73) Assignee: NATIONAL TSING HUA UNIVERSITY, Hsinchu City (TW)

(21) Appl. No.: 14/828,022

(22) Filed: Aug. 17, 2015

(51) Int. Cl. B29C 33/38; B29C 39/02; B29C 35/02; B29C 39/00; C09K 3/18; B29C 33/42

(52) U.S. Cl. CPC B29C 33/3892; C09K 3/18; B29C 33/3878; B29C 33/42; B29C 35/02; B29C 39/003; B29C 39/026; B29K 2995/0093; B29K 2083/00

(57) ABSTRACT

A superhydrophobic structure with droplet-guiding capability includes: a substrate having a surface and front and rear sides; and a plurality of oblique cones exhibiting superhydrophobic properties and protruding frontwardly and obliquely from the surface in an inclined direction inclined to the surface, so that liquid droplets are guided by the oblique cones to move therealong when the liquid droplets move frontwardly from the rear side toward the front side and so that the liquid droplets move against the oblique cones when the liquid droplets move rearwardly from the front side toward the rear side. A method of making the superhydrophobic structure is also disclosed.

### FIELD

This invention relates to a superhydrophobic structure and a method of making the same, more particularly to a superhydrophobic structure that includes a plurality of oblique cones having droplet-guiding capability.

### BACKGROUND

A conventional hydrophobic film includes a substrate and a micro-structure which is formed on the substrate. The micro-structure has a plurality of protrusions which protrude vertically from a surface of the substrate.

Although the conventional hydrophobic film exhibits hydrophobic properties, the same does not have functions of guiding liquid droplets to move or roll thereon in a predetermined direction. In addition, the conventional hydrophobic film may still have a tendency to hold liquid droplets thereon, which is undesirable in many applications, such as being used on a windshield window.

### SUMMARY

Therefore, an object of the disclosure is to provide a superhydrophobic structure with droplet-guiding capability that can overcome the aforesaid drawback of the prior art.

According to one aspect of the disclosure, there is provided a superhydrophobic structure with droplet-guiding capability that includes a substrate and a plurality of oblique cones.

The substrate has a surface and front and rear sides.

The oblique cones exhibit superhydrophobic properties and protrude frontwardly and obliquely from the surface of the substrate in an inclined direction inclined to the surface of the substrate, so that liquid droplets are guided by the oblique cones to move therealong when the liquid droplets move frontwardly from the rear side toward the front side and that the liquid droplets move against the oblique cones when the liquid droplets move rearwardly from the front side toward the rear side.

Another object of the disclosure is to provide a method of making a superhydrophobic structure that can overcome the aforesaid drawback of the prior art.

According to another aspect of the disclosure, there is provided a method of making a superhydrophobic structure. The method includes: (a) applying a magnetic field to a ferrofluid on a plate-like base which is inclined to the magnetic field so as to form a plurality of spaced apart oblique ferrofluid cones on the plate-like base, the plate-like base and the oblique ferrofluid cones cooperatively defining a carrier; (b) molding a moldable material over the oblique ferrofluid cones of the carrier so as to form a template that is formed with a pattern of conical recesses corresponding respectively to the oblique ferrofluid cones; (c) separating the template from the carrier; and (d) filling a curable material in the recesses in the template; (e) curing the curable material in the recesses in the template to form a cured material; and (f) separating the cured material from the template.

### BRIEF DESCRIPTION OF THE DRAWINGS

Other features and advantages of the disclosure will become apparent in the following detailed description of the embodiments of this invention, with reference to the accompanying drawings, of which:

FIG. 1 is a perspective view of the first embodiment of a superhydrophobic structure according to this disclosure;

FIG. 2 is a cross-sectional view of the first embodiment;

FIG. 3 is a cross-sectional view of the second embodiment of the superhydrophobic structure according to this disclosure;

FIGS. 4 to 8 are schematic views illustrating consecutive steps of a method of making the second embodiment of the superhydrophobic structure according to this disclosure;

FIG. 9 shows images of oblique ferrofluid cones, in which the oblique ferrofluid cones in each image have a corresponding one of inclined angles (θ) 1°, 25°, 50°, 70° and 90°;

FIG. 10 shows SEM images of oblique cones, in which the oblique cones in each image have a corresponding one of inclined angles (θ) 1°, 25°, 50°, 70° and 90°;

FIG. 11 is a plot of inclined angle (θ) of the oblique cones vs. contact angle (t) of a liquid droplet on a suprehydrophobic structure;

FIG. 12 is a schematic view illustrating the contact angle (t) of the liquid droplet on a contact surface;

FIG. 13 shows images of the liquid droplet on the suprehydrophobic structure without the oblique cones (i.e., flat PDMS) or the suprehydrophobic structures with the oblique cones, in which the oblique cones in each image have a corresponding one of inclined angles (θ) 1°, 25°, 50°, 70° and 90°;

FIG. 14 is a schematic view illustrating a release state in which a rear side of the embodiment of the superhydrophobic structure is lifted at a roll-off angle (α) with respect to a horizontal plane f2;

FIG. 15 is a schematic view illustrating a pin state, in which a front side of the embodiment of the superhydrophobic structure is lifted at a roll-off angle (α) with respect to a horizontal plane f2;

FIG. 16 is a plot of inclined angle (θ) vs. roll-off angle (α) under a release state and a pin state;

FIG. 17 is a plot of inclined angle (θ) vs. droplet retention force under the pin state; and

FIG. 18 is a plot of inclined angle θ vs. droplet retention force under the release state.

### DETAILED DESCRIPTION

Before the disclosure is described in greater detail, it should be noted that like elements are denoted by the same reference numerals throughout the disclosure.

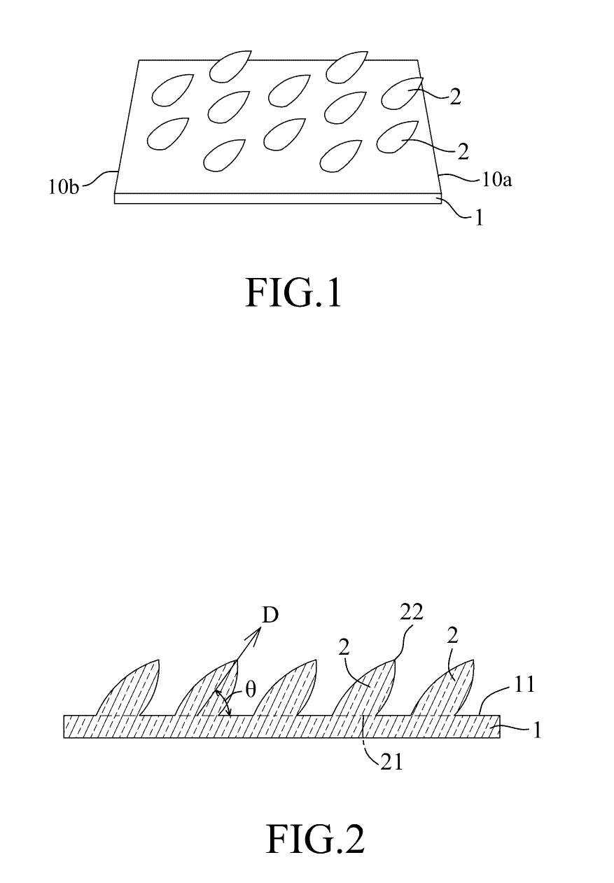

Referring to FIGS. 1 and 2, the first embodiment of a superhydrophobic structure with droplet-guiding capability according to the disclosure is shown to include a substrate 1 and a plurality of oblique cones 2. The superhydrophobic structure may be applied to articles, such as windshield windows, car windows, house windows, etc., so as to provide functions, such as guiding liquid droplets to move or roll on the windshield windows along a predetermined direction or preventing the liquid droplets from being adhered to the windshield windows.

The substrate 1 has a surface 11 and front and rear sides 10a, 10b.

The oblique cones 2 protrude frontwardly and obliquely from the surface 11 of the substrate 1 in an inclined direction (D) inclined to the surface 11 of the substrate 1, and exhibit superhydrophobic properties, so that liquid droplets (not shown) are guided by the oblique cones 2 to move therealong when the liquid droplets move frontwardly from the rear side 10b toward the front side 10a and so that the liquid droplets move against the oblique cones 2 when the liquid droplets move rearwardly from the front side 10a toward the rear side 10b.

In the first embodiment, the surface 11 of the substrate 1 is flat. Each of the oblique cones 2 has a base end 21 that is in contact with the surface 11, and a tip end 22 that is distal from the surface 11 of the substrate 1. Each of the oblique cones 2 is tapered from the base end 21 to the tip end 22 along the inclined direction (D). The base end 21 of each of the oblique cones 2 has a peripheral edge 211 that is in contact with the surface 11 of the substrate 1 and that has a diameter greater than 10 nm and less than 300 μm. Each of the oblique cones 2 has a height from the surface 11 of the substrate 1, that is greater than 10 nm and less than 500 μm.

In certain embodiments, the base end 21 of each of the oblique cones 2 may be circular or polygonal in shape.

In certain embodiments, the inclined direction (D) and the surface 11 of the substrate 1 cooperatively define an inclined angle (θ) greater than 35 degrees and less than 65 degrees.

In the first embodiment, the oblique cones 2 are arranged in an array.

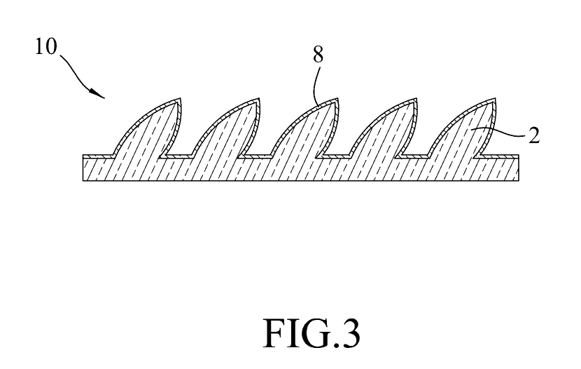

Referring to FIG. 3, the second embodiment of the superhydrophobic structure according to the disclosure is shown to have a structure similar to that of the first embodiment. The second embodiment differs from the previous embodiment in that the second embodiment further includes a hydrophobicity-enhancing layer 8 formed on the oblique cones 2. The hydrophobicity-enhancing layer 8 may be made from metal or a polymeric material. The polymer material may be in the form of polymer fibers.

The following description illustrates a method of making the superhydrophobic structure of the second embodiment of the disclosure, which should not be construed as limiting the scope of the disclosure.

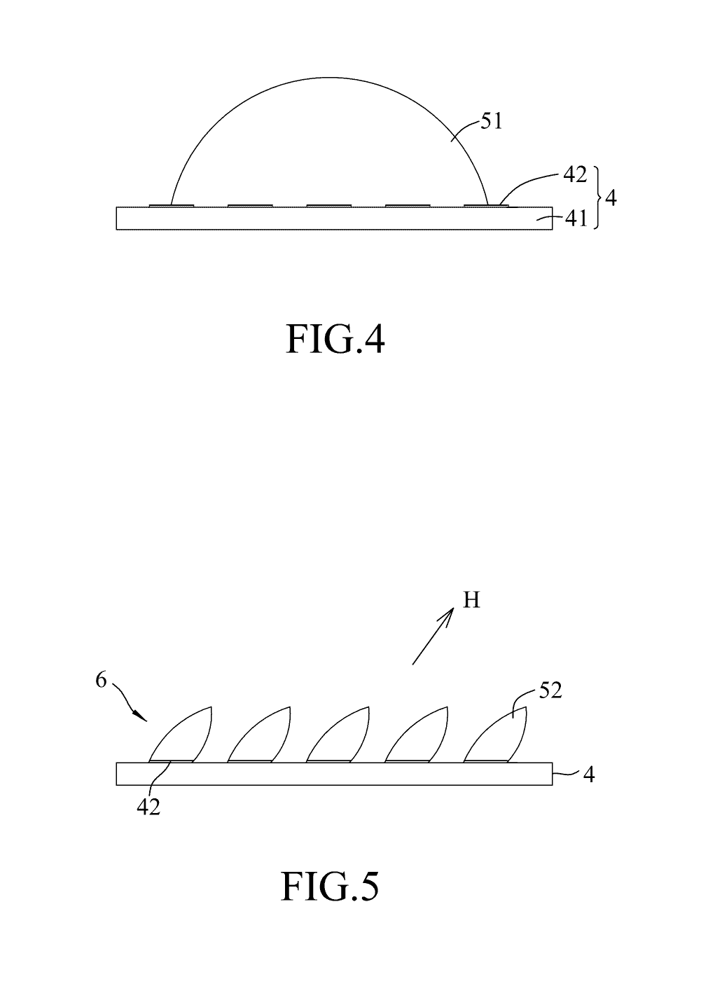

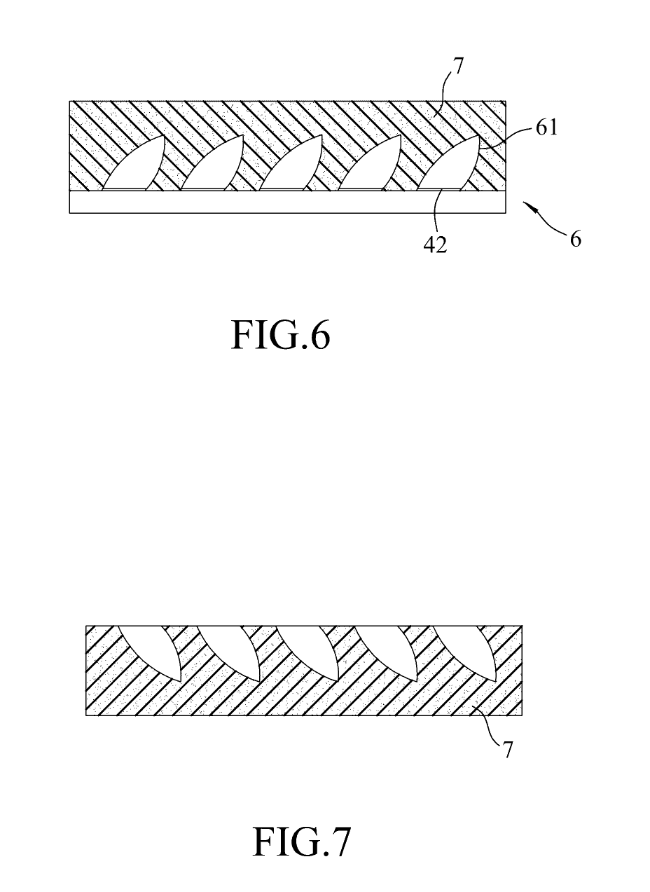

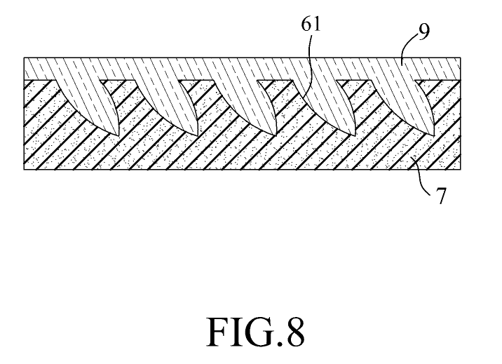

The method includes the steps of: applying a ferrofluid 51 on a plate-like base 4 (see FIG. 4); applying a magnetic field (H) to the ferrofluid 51 on the plate-like base 4 which is inclined to the magnetic field (H) so as to form the ferrofluid 51 into a plurality of spaced apart oblique ferrofluid cones 52 on the plate-like base 4 (see FIG. 5), the plate-like base 4 and the oblique ferrofluid cones 52 cooperatively defining a carrier 6; molding a moldable material over the oblique ferrofluid cones 52 of the carrier 6 so as to forma template 7 that is formed with a pattern of conical recesses 61 corresponding respectively to the oblique ferrofluid cones 52 (see FIG. 6); separating the template 7 from the carrier 6 (see FIG. 7); filling a curable material in the conical recesses 61 of the template 7; curing the curable material to form a cured material 9 (see FIG. 8); separating the cured material 9 from the template 7; and forming the hydrophobicity-enhancing layer 8 on the cured material 9 so as to form the superhydrophobic structure 10 (see FIG. 3).

In more detail, the plate-like base 4 includes a plate 41 and a plurality of magnetic pads 42 which are formed on the plate 41 and which are spaced apart from each other, so that when the magnetic field (H) is applied to the ferrofluid 51 on the plate-like base 4, the magnetic pads 42 are magnetically associated with the magnetic field to form the ferrofluid 51 into the oblique ferrofluid cones 52 thereon.

In this embodiment, the curable material is polydimethylsiloxane (PDMS).

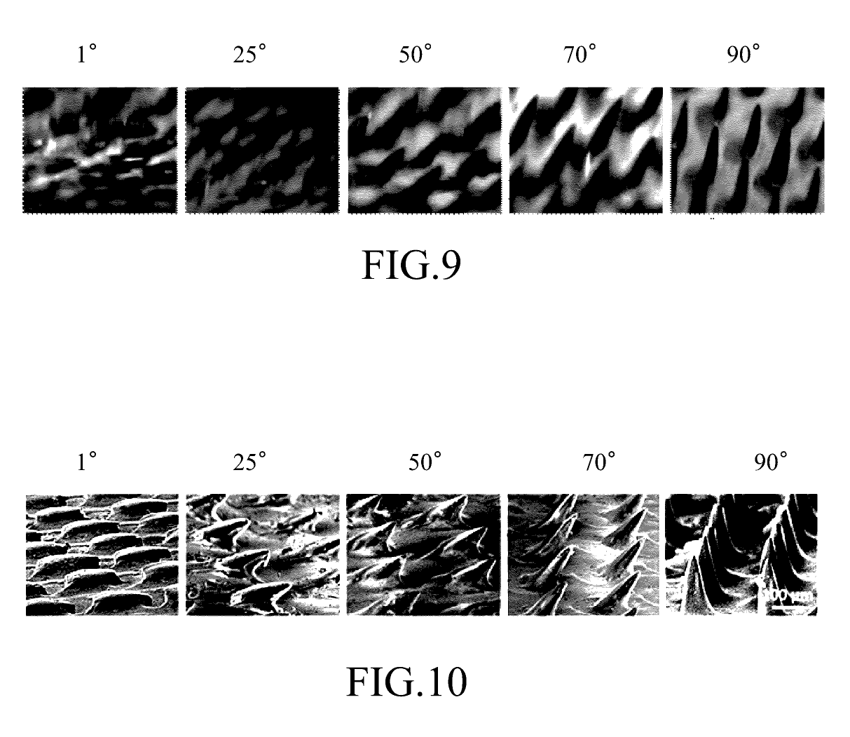

FIG. 9 shows images of the oblique ferrofluid cones on the plate-like bases 4, in which the oblique ferrofluid cones in each image have a corresponding one of inclined angles 1°, 25°, 50°, 70°, and 90°) with respect to a surface of the plate-like base 4. FIG. 10 shows images of the oblique cones 2 of the superhydrophobic structures, in which the oblique cones 2 in each image have a corresponding one of inclined angles 1°, 25°, 50°, 70°, or 90°.

<Analysis Data>

[Hydrophobic Test]

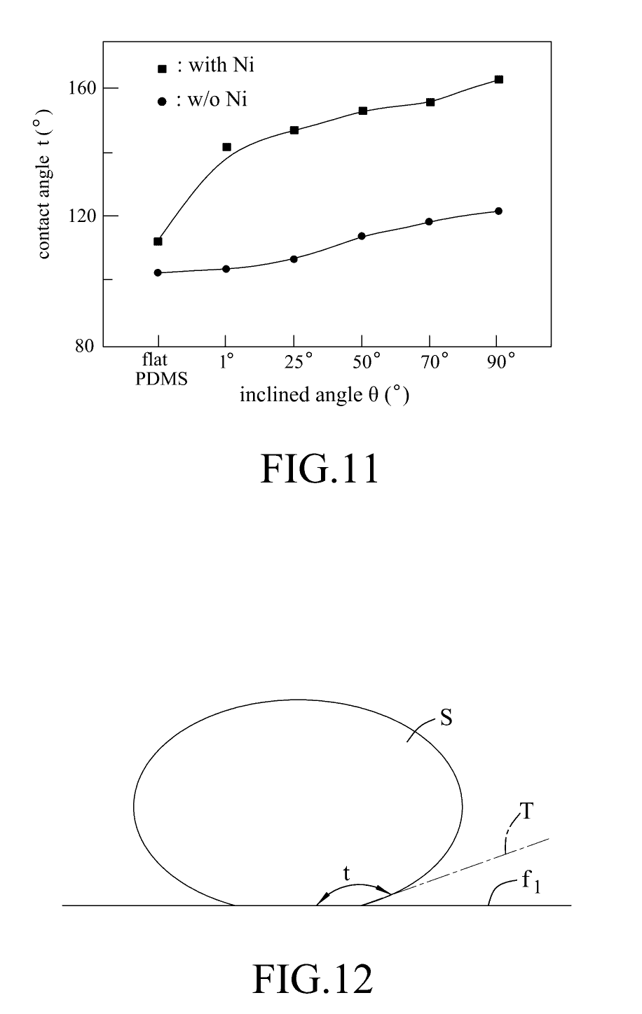

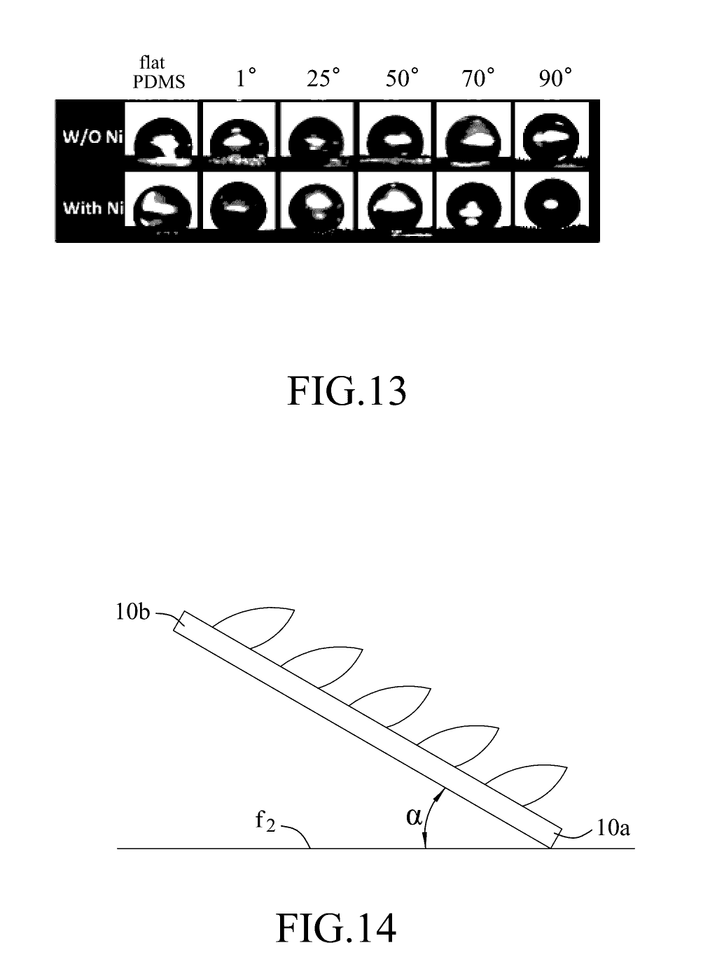

FIG. 11, in combination with FIG. 12, is a plot of the inclined angle (θ) of the oblique cones 2 vs. contact angle (t) of a liquid droplet (S) on a contact surface (f₁). In this embodiment, the contact surface (f₁) is the surface 11 of the substrate 1. The contact angle (t) of the liquid droplet (S) is defined by the contact surface (f₁) and the tangent line (T) of the liquid droplet (S) as shown in FIG. 12. It is noted that the flat PDMS shown in FIG. 11 represents the superhydrophobic structure without any oblique cones 2 formed on the substrate 1. The square symbol in FIG. 11 represents the superhydrophobic structure of the second embodiment (i.e., with the hydrophobicity-enhancing layer 8 made from nickel). The circle symbol in FIG. 11 represents the superhydrophobic structure of the first embodiment (i.e., without the hydrophobicity-enhancing layer 8). The photo images of the liquid droplet (S) on each of the superhydrophobic structures are shown in FIG. 13.

The results of FIG. 13 show that the contact angle (t) of the liquid droplet (S) on the superhydrophobic structure with the oblique cones 2 is greater than that on the flat PDMS without the oblique cones 2. Moreover, as shown in FIGS. 11 and 13, the greater the inclined angle (θ), the greater the contact angle (t) will be. FIGS. 11 and 13 further show that the hydrophobicity-enhancing layer 8 improves the hydrophobic capability.

[Droplet Rolling-Off Test]

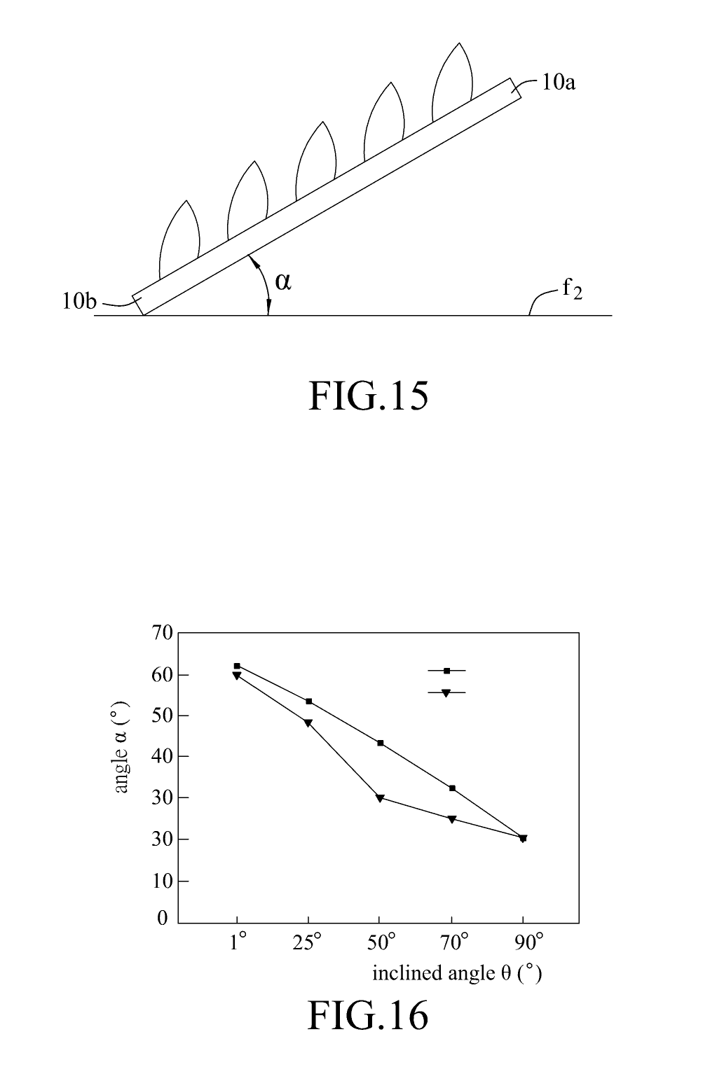

The droplet rolling-off test was used to measure a roll-off angle (α) of the superhydrophobic structure with respect to a horizontal plane (f₂) at a release state (see FIG. 14) or a pin state (see FIG. 15). The roll-off angle (α) at the release state was measured by gradually lifting the rear side 10b (see FIG. 14) of the superhydrophobic structure from the horizontal plane (f₂) with the front side 10a serving as a pivot point until the liquid droplet starts to roll downwardly along the superhydrophobic structure. The roll-off angle (α) at the pin state was measured by gradually lifting the front side 10a (see FIG. 15) of the superhydrophobic structure from the horizontal plane (f₂) with the rear side 10b serving as a pivot point until the liquid droplet starts to roll downwardly along the superhydrophobic structure.

FIG. 16 is a plot of the inclined angle (θ) vs. the roll-off angle (α) of the superhydrophobic structure at the release state (represented by the inverted triangle symbol) and the pin state (represented by the square symbol). As shown in FIG. 16, when the inclined angle (θ) is not less than 1° and less than 90°, the roll-off angle (α) at the release state is less than the roll-off angle (α) at the pin state. The result shows that the oblique cones 2 of the superhydrophobic structure can be arranged in such a manner to guide or direct movement of the liquid droplets thereon along a predetermined direction. When the inclined angle (θ) is greater than 35 degrees and less than 65 degrees, the difference in the roll-off angle (α) between the release state and the pin state is more distinct.

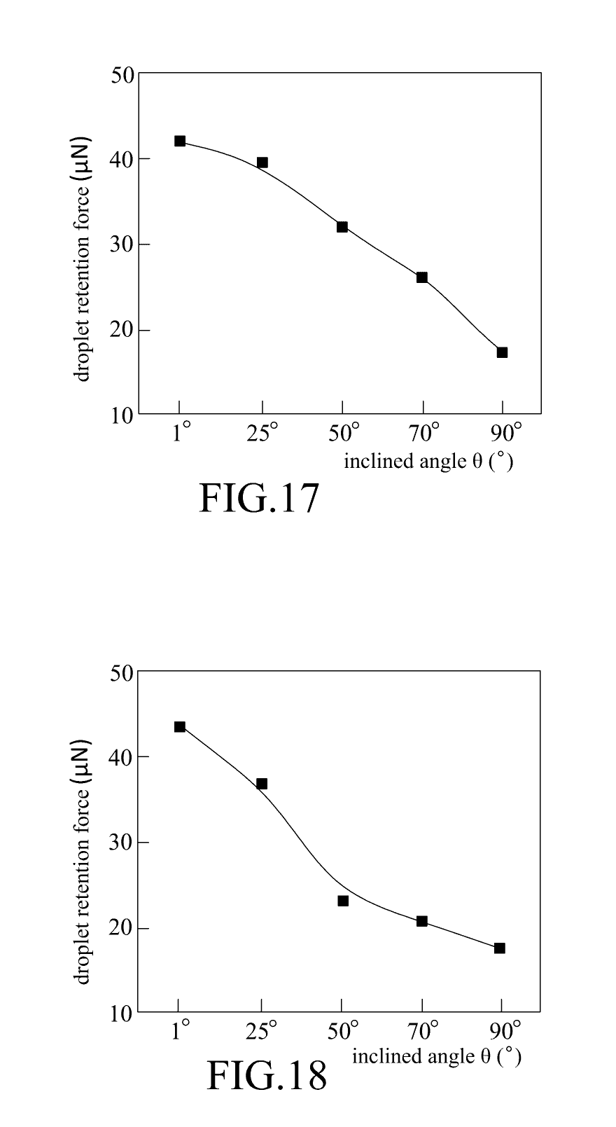

FIG. 17 is a plot of the inclined angle (θ) vs. a droplet retention force for the superhydrophobic structure under the pin state. FIG. 18 is a plot of the inclined angle (θ) vs. the droplet retention force for the superhydrophobic structure under the release state. The results show that, at the inclined angle (θ) of not less than 1° and less than 90°, the droplet retention force of the superhydrophobic structure under the pin state is greater than that under the release state, i.e., the resistance to the movement of the liquid droplet on the superhydrophobic structure under the pin state is greater than that under the release state. Moreover, at the inclined angle (θ) of greater than 35° and less than 65°, the difference in the retention force between the pin state and the release state is more prominent.

With the inclusion of the oblique cones 2 in the superhydrophobic structure of the present disclosure, the aforesaid drawbacks associated with the prior art can be alleviated.

While the disclosure has been described in connection with what are considered the most practical embodiments, it is understood that this invention is not limited to the disclosed embodiments but is intended to cover various arrangements included within the spirit and scope of the broadest interpretation and equivalent arrangements.

What is claimed is:

1. A superhydrophobic structure with droplet-guiding capability, comprising:
a substrate having a surface and front and rear sides; and
a plurality of oblique cones exhibiting superhydrophobic properties and protruding frontwardly and obliquely from said surface of said substrate in an inclined direction inclined to said surface of said substrate, so that liquid droplets are guided by said oblique cones to move therealong when the liquid droplets move frontwardly from said rear side toward said front side and so that the liquid droplets move against said oblique cones when the liquid droplets move rearwardly from said front side toward said rear side.

2. The superhydrophobic structure of claim 1, wherein said surface of said substrate is flat, each of said oblique cones having a base end that is in contact with said surface, and a tip end that is distal from said surface, each of said oblique cones being tapered from said base end to said tip end along said inclined direction.

3. The superhydrophobic structure of claim 1, wherein said base end of each of said oblique cones is circular or polygonal in shape.

4. The superhydrophobic structure of claim 1, wherein said inclined direction and said surface of said substrate cooperatively define an inclined angle greater than 35 degrees and less than to 65 degrees.

5. The superhydrophobic structure of claim 1, further comprising a hydrophobicity-enhancing layer which is formed on said oblique cones and which is made from metal or a polymer material.

6. The superhydrophobic structure of claim 1, wherein said oblique cones are arranged in an array.

7. The superhydrophobic structure of claim 1, wherein said base end of each of said oblique cones has a peripheral edge that is in contact with said surface of said substrate and that has a diameter greater than 10 nm and less than 300 μm, each of said oblique cones having a height greater than 10 nm and less than 500 μm.

8. A method of making a superhydrophobic structure, comprising:
(a) applying a magnetic field to a ferrofluid on a plate-like base which is inclined to the magnetic field so as to form a plurality of spaced apart oblique ferrofluid cones on the plate-like base, the plate-like base and the oblique ferrofluid cones cooperatively defining a carrier;
(b) molding a moldable material over the oblique ferrofluid cones of the carrier so as to form a template that is formed with a pattern of conical recesses corresponding respectively to the oblique ferrofluid cones;
(c) separating the template from the carrier; and
(d) filling a curable material in the recesses in the template;
(e) curing the curable material in the recesses in the template to form a cured material; and
(f) separating the cured material from the template.

9. The method of claim 8, wherein the plate-like base includes a plate and a plurality of magnetic pads which are formed on the plate and which are spaced from each other.

10. The method of claim 8, wherein the curable material is polydimethylsiloxane (PDMS).
